(19) United States
(12) Patent Application Publication
(10) Pub. No.: US 2021/0342213 A1
(43) Pub. Date: Nov. 4, 2021

(54) Processing Device, Control Unit, Electronic Device, Method and Computer Program

(71) Applicants: Karunakara KOTARY, Portland, OR (US); Toby OPFERMAN, Portland, OR (US); Deepak GANDIGA SHIVAKUMAR, Beaverton, OR (US); Vijay C. BAHIRJI, Beaverton, OR (US); Rajesh POORNACHANDRAN, Portland, OR (US)

(72) Inventors: Karunakara KOTARY, Portland, OR (US); Toby OPFERMAN, Portland, OR (US); Deepak GANDIGA SHIVAKUMAR, Beaverton, OR (US); Vijay C. BAHIRJI, Beaverton, OR (US); Rajesh POORNACHANDRAN, Portland, OR (US)

(21) Appl. No.: 17/375,158

(22) Filed: Jul. 14, 2021

(51) Int. Cl. G06F 11/07; G06F 9/48; G06F 9/38

(52) U.S. Cl. CPC G06F 11/0724; G06F 9/3891; G06F 9/4812

(57) ABSTRACT

A processing device is provided. The processing device comprises an interface configured to receive information about an operation state of a surrogate processor. Further, the processing device comprises a processing circuitry configured to decide whether an interrupt addressed to the processing circuitry is processed by the processing circuitry or redirected to the surrogate processing circuitry based on an operation state of the processing circuitry and the surrogate processing circuitry.

### FIELD

The present disclosure relates to the field of lock-step mode. In particular, examples relate to a processing device, a control unit, an electronic device, a method and a computer program.

### BACKGROUND

Lock-step mode comprises at least two cores, namely a leader and a follower core, where the followers core mirrors instructions executed on the leader core such that on any given clock cycle, they are at an identical well-defined state. Typically, such a mechanism is used on systems to provide high reliability where a comparator is used to compare leader and follower cores' output to predict failures in real time.

Lock-step mode requires that two identical cores running the same operation produce the same output at any given clock cycle. This process of comparing the output of these two cores is done by a comparator that determines if the lock-step cores are running normally. An event where the output of the two cores does not match is a mis-compare and may result in breaking out of lock-step mode.

However, the lock-step mode can only be maintained as long as the leader and the follower cores function without errors. If an error in only one core occurs a restart of both cores may be necessary, leading to a decreased performance. Thus, there may be a need for an improved maintaining of the leader and the follower core.

### BRIEF DESCRIPTION OF THE FIGURES

Some examples of apparatuses and/or methods will be described in the following by way of example only, and with reference to the accompanying figures, in which

FIG. 1 shows a block diagram of an example of a processing device;

FIG. 2 shows a block diagram of an example of a control unit;

FIG. 3 shows a block diagram of an example of an electronic device;

FIG. 4 shows an example of a system architecture of a system including the electronic device from FIG. 3;

FIG. 5 shows a flow chart of an example of a method;

FIG. 6 shows a flow chart of another example of a method; and

FIG. 7 shows an example of another method.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, e.g., only A, only B as well as A and B. An alternative wording for the same combinations is “at least one of the group A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

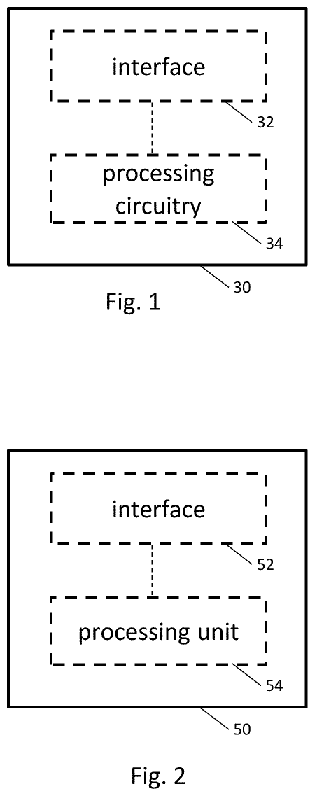

FIG. 1 shows a block diagram of an example of a processing device 30. The processing device 30 comprises one or more interfaces 32 configured to transmit information to a follower processing circuitry and a processing circuitry 34 configured to control the one or more interfaces 32. Further, the processing circuitry 34 is configured to gather operation state information of the processing circuitry 34 and to determine an operation state of the processing circuitry 34 based on the gathered operation state information. Further, if the determined operation state indicates an erroneous operation state the processing circuitry 34 is configured to transmit information about the erroneous operation state to the follower processing circuitry.

The processing circuitry 34 and the follower processing circuitry operate in a lock-step mode. For example, the follower processing circuitry mirrors the instructions executed on the processing circuitry 34. Thus, the processing circuit 34 can operate as leader core and the follower processing circuitry can operate as follower core in a lock-step mode or vice versa. As mentioned, the leader core and the follower core execute the same instruction, wherein the leader core is responsible for maintaining the lock-step mode.

An entire system may comprise the processing circuitry 34 and the follower processing circuitry resulting in an improved reliability of the entire system, due to the lock-step mode of the processing circuitry 34 and the follower processing circuitry.

By determining if the operation state indicates an erroneous operation state the processing circuitry 34 is enabled to inform the follower processing circuitry about an (actual) operation state of its own. For example, the processing circuitry 34 may determine an erroneous operation state, such that a restart of the processing device 30 may be required. Thus, the processing circuitry 34 may inform the follower processing circuitry that it will restart its own, resulting in a termination of the lock-step mode. Thus, the follower processing circuitry may break out of the lock-step mode and may be the only core that executes instructions of the lock-step mode preventing a shut-down of the entire system. In this way, instead of shutting-down the entire system (comprising the processing circuitry 34 and the follower processing circuitry) the follower processing circuitry is enabled to continue operation resulting in continued operation of the entire system. An erroneous operation state may be caused by a hardware error.

Further, the determination of the operation state may offer an improved resiliency by allowing the processing circuitry 34 to take corrective action where possible. For example, the processing may determine an erroneous operation state, which can be corrected by a restart and thus the processing circuitry 34 may initiate a restart of its own. During the restart is performed the follower processing circuitry may be the only core that performs instructions of the lock-step mode and after the restart the lock-step mode is continued. This may enhance an uptime of the entire system. Increased uptime of servers comprising the processing circuitry 34 in a datacenter with a fleet of servers may lead to an improved availability and/or may achieve a better service level agreement.

For example, if the lock-step mode may be terminated (e.g., the processing circuitry 34 needs to restart) the follower processing circuitry may increase a rate of gathering operation state information of its own, e.g., increase a self-check rate (e.g., a rate of machine check) to maintain its own operation state to increases the possibility to detect an erroneous operation state of its own. Additionally or alternatively, the follower processing circuitry and/or the processing circuitry 34 may contact/instruct a surrogate processing circuitry, which mirrors the instruction executed on the follower processing circuitry to reestablish the lock-step mode. For example, the processing circuitry 34 may determine an erroneous operation state, may inform the follower processing circuitry about this erroneous operation state and may also migrate execution instruction to a surrogate processing circuitry. The surrogate processing circuitry may execute the execution instruction for a downtime of the processing circuitry. Thus, by migrating the execution instruction to a surrogate processing circuitry an uptime of the lock-step mode can be increased, and a downtime of the entire system may be decreased still providing an improved reliability.

The operation state information may be gathered by the processing circuitry 34 on its own, e.g., using a machine check (e.g., determining error source, error reason etc.) and/or may be received, e.g., from an observation circuitry, e.g., from a phasor measurement unit (PMU). Thus, the processing circuitry 34 can be enabled to identify (graceful/recoverable) erroneous operation states of its own.

In an example, the processing circuitry 34 may be further configured to transmit an output of an instruction executed by the processing circuitry 34 to a comparator circuitry and to receive comparison information about a lock-step mode from the comparator circuitry. Further, the determination of the operation state is based on the gathered operation state information and the comparison information. So a detection of an erroneous operation state with impact on the output of the processing circuitry 34 can be improved.

For example, the comparator circuitry may receive an output of an instruction executed by the processing circuitry 34 and the follower processing circuitry. Thus, by comparing the outputs the comparator circuitry can identify a mis-comparison, which indicates that the processing circuitry 34 and/or the follower processing circuitry has an erroneous operation state. This information can be received by the processing circuitry 34, such that the processing circuitry 34 may only terminate the lock-step mode if both information, operation state information and comparison information, indicate an erroneous operation. In this way, an erroneous operation state without impact on the output of the processing circuitry 34 may not lead to a termination of the lock-step mode, increasing a reliability of the entire system.

As shown in FIG. 1 the respective one or more interfaces 32 are coupled to the respective processing circuitry 34 at the processing device 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the interface 32, so that any data transfer that occurs over the interface and/or any interaction in which the interface may be involved may be controlled by the processing circuitry 34.

In an embodiment the processing device 30 may comprise a memory and at least one processing circuitry 34 operably coupled to the memory and configured to perform the below mentioned method.

In examples the one or more interfaces 32 may correspond to any means for obtaining, receiving, transmitting or providing analog or digital signals or information, e.g., any connector, contact, pin, register, input port, output port, conductor, lane, etc. which allows providing or obtaining a signal or information. An interface may be wireless or wireline and it may be configured to communicate, e.g., transmit or receive signals, information with further internal or external components. The one or more interfaces 32 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described below. The example shown in FIG. 1 may comprise one or more optional additional features corresponding to one or more aspects mentioned in connection with the proposed concept or one or more examples described below (e.g., FIG. 2-7).

FIG. 2 shows a block diagram of an example of a control unit 50. The control unit 50 comprises one or more interfaces 52 configured to communicate with a processing device (e.g., the processing device as described with reference to FIG. 1) and a follower processing device and a processing unit 54 configured to control the one or more interfaces 52. Further, the processing unit 54 is configured to gather operation state information of the processing device and to determine an operation state of the processing device based on the gathered operation state information. Further, if the determined operation state indicates an erroneous operation state the processing unit 54 is further configured to transmit information about the erroneous operation state to the follower processing circuitry and/or the processing device. Thus, the processing unit 54 can inform the follower processing device about an erroneous operation state, which may result in a termination of the lock-step mode, e.g., because the processing device needs to restart.

The processing device and the follower processing device operate in a lock-step mode. For example, the follower processing device mirrors the instructions executed on the processing device. Thus, the processing device can operate as leader core and the follower processing device can operate as follower core in a lock-step mode or vice versa. An entire system may comprise the processing device and the follower processing device resulting in an improved reliability of the entire system, due to the lock-step mode of the processing device and the follower processing device.

By determining if the operation state indicates an erroneous operation state the control unit 50 may be enabled to inform the follower processing device and/or the processing device about an actual operation state of the processing device. In principle, the control unit can perform the same actions as the processing circuitry as described with reference to FIG. 1. For example, the control unit 50 may determine an erroneous operation state of the processing device, such that a restart of the processing device may be required. Thus, the control unit 50 may inform the processing device about this erroneous operation state, which may lead to a restart of the processing device resulting in a termination of the lock-step mode. Further, the control unit 50 may inform the follower processing device about a termination of the lockstep mode, enabling the follower processing device to break out of the lock-step mode. Thus, the follower processing device may be the only core that execute instructions of the lock-step mode preventing a shut-down of the entire system. In this way, instead of shutting-down the entire system (comprising the processing device and the follower processing device) the control unit 50 can maintain the follower processing device in an active operation state resulting in continued operation of the entire system, while the processing device may restart.

Furthermore, in comparison to the processing device described with reference to FIG. 1 the control unit 50 may be capable to determine a catastrophic error (cater) of the processing device (e.g., the processing circuitry of the processing device). Thus, even if the processing device cannot transmit a message to the follower processing device because of a cater, the control unit 50 can inform the follower processing device increasing a reliability of the entire system.

For example, the control unit 50 can inform the processing device and/or the follower processing device about an erroneous operation state of the processing device that allows the entire system to continue operation by solely using the follower processing device instead of bringing down the entire system. It offers resiliency by allowing the control unit 50 to take corrective action where possible and to allow the processing devices having an erroneous operation state to be off lined, e.g., permanently. This may enhance uptime Service-Level Agreements on data center platforms, provide an edge over other platforms in providing high degree of resiliency and/or add value to the Total Cost of Ownership story. As more and more processing devices and/or follower processing devices are packed into a data center, the need to increase uptime as much as possible increases.

For example, if the lock-step mode may be terminated (e.g., the processing device needs to restart) the follower processing device and/or the control unit 50 may increase a rate of gathering operation state information of the follower processing device, e.g., increase a self-check rate (e.g., a rate of machine check) to maintain its operation state to increases the possibility to detect an erroneous operation state of its own. Additionally or alternatively, the control unit 50 may contact/instruct a surrogate processing device, which mirrors the instruction executed on the follower processing device to reestablish the lock-step mode. Thus, by migrating the execution instruction to a surrogate processing device an uptime of the lock-step mode can be increased, and a downtime of the entire system may be decreased still providing an improved reliability.

The operation state information may be gathered by the control unit 50 by receiving information from the processing device/follower processing device (e.g., information about a machine check, output information about an executed instruction to check for mis-comparison etc.) and/or from an observation device, e.g., from a PMU (e.g., physical parameter such like temperature, energy consumption etc. of the processing device). Thus, the control unit 50 can be enabled to identify graceful/recoverable erroneous operation states and/or cater operation states. For example, information about a machine check may comprise the error source, error reason and/or lockstep break etc. The control unit 50 may have the capability to queue up the machine check error data from a machine check bank that can be processed based on a configured policy-based order (e.g., First In, First Out (FIFO)). This may provide the capability to scale out and scale-up in terms of a handling array of processing devices e.g., across one or more sockets.

For example, the control unit 50 may assign an erroneous operation state to the processing device only if several conditions are fulfilled, e.g., a mis-compare of output information of an executed information (from the processing device and the follower processing device) and an indication of an erroneous operation by a machine check of the processing device. So a detection of an erroneous operation state with impact on the output of the processing device can be improved.

For example, the control unit 50 may migrate instructions to be executed on a processing device having an erroneous operation state to a surrogate processing device. The migration may depend on a use case. For example, for a system with a small amount of processing devices executing the same instruction (e.g., only one processing device and one follower processing device), e.g., as typically used for an autonomous vehicle a requirement for a system reliability is greatly increased, since every miscalculation can end in a crash of the autonomous vehicle. Thus, by migrating instructions a termination of a lock-step mode can be omitted, resulting in an improved system reliability. For example, for a system with a high amount of processing devices executing the same instruction (e.g., a data center with thousands of processing devices/follower processing devices) a migration may be unnecessary. However, even if a migration may be unnecessary the identification of an erroneous operation state of the processing device may lead e.g., to a permanent shut-down of the processing device, thus that no mis-comparison can be triggered anymore by the processing device, increasing a performance of the system.

As shown in FIG. 2 the respective one or more interfaces 52 are coupled to the respective processing unit 54 at the control unit 50. In examples the processing unit 54 may be implemented using one or more processing units, one or more processing devices, any means for processing, such as a processor, a computer or a programmable hardware component being operable with accordingly adapted software. Similar, the described functions of the processing unit 54 may as well be implemented in software, which is then executed on one or more programmable hardware components. Such hardware components may comprise a general-purpose processor, a Digital Signal Processor (DSP), a micro-controller, etc. The processing unit 54 is capable of controlling the interface 52, so that any data transfer that occurs over the interface and/or any interaction in which the interface may be involved may be controlled by the processing unit 54.

In an embodiment the control unit 50 may comprise a memory and at least one processing unit 54 operably coupled to the memory and configured to perform the below mentioned method.

In examples the one or more interfaces 52 may correspond to any means for obtaining, receiving, transmitting or providing analog or digital signals or information, e.g., any connector, contact, pin, register, input port, output port, conductor, lane, etc. which allows providing or obtaining a signal or information. An interface may be wireless or wireline and it may be configured to communicate, e.g., transmit or receive signals, information with further internal or external components. The one or more interfaces 52 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

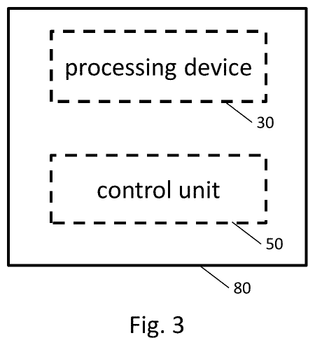

More details and aspects are mentioned in connection with the examples described above and/or below. The example shown in FIG. 2 may comprise one or more optional additional features corresponding to one or more aspects mentioned in connection with the proposed concept or one or more examples described above (e.g., FIG. 1) and/or below (e.g., FIG. 3-7).

FIG. 3 shows a block diagram of an example of an electronic device 80. The electronic device 80 comprises a processing device 30, e.g., the processing device as described above (e.g., FIG. 1) and/or a control unit 50, e.g., the control unit as described above (e.g., FIG. 2). In another example, the control unit 50 may be connected to the processing device 30 with an interface. For example, the processing device 30 may be configured/maintained by the control unit 50, e.g., a processing device 30 having an erroneous operation state may be shut down by the control unit 50.

In an example, the electronic device 80 may further comprise an observing circuitry configured to observe the operation state of the processing device 30 and/or the follower processing device. Further, the observing circuitry may be configured to transmit information about the observed operation state to the processing device 30 and/or the control unit 50. The observing circuitry (e.g., a PMU) can be capable to measure a physical parameter of the processing device 30, e.g., an energy consumption, temperature etc. Thus, the processing device 30 and/or the control unit 50 can be informed about an operation state of the processing device 30.

In an example, the control unit 50 may be further configured to store information about an operation state of the processing device 30. Thus, the control unit 50 may be enabled to generate e.g., a performance profile over time of the processing device 30. Utilizing the performance profile the control unit 50 may determine a repetitive erroneous operation state of the processing device 30. Therefore, a determination of an erroneous operation state of the processing device 30 may be improved. For example, a maximum number of erroneous operations states in time may be defined and if the repetitive erroneous operation state exceeds the maximum number in time the processing device 30 is shut down.

In an example, the electronic device 80 may further comprise a transfer circuitry. The transfer circuitry may be configured to receive telemetry information about the processing device 30 and/or the follower processing device from a system management domain and to transmit the received telemetry information to a management console. The telemetry information may be determined by the observing circuitry. The telemetry information may be used to monitor the processing device 30. For example, the telemetry information may comprise a load, an availability, a disk space usage, a memory consumption, a performance etc. of the electronic device 80. The telemetry information can be used to maximize an uptime and/or a performance of the electronic device 80. For example, the electronic device 80 may be a data center, where multiple data center processing devices 30 have been shut down, e.g., because of exceeding a maximum number of erroneous operation states in time. The telemetry information may indicate a high load of the data center, which may lead to an undesired energy consumption and/or decrease in user experience. Thus, the maximum number of erroneous operation states in time may be increased (e.g., by the control unit 50) leading to a restart of the multiple data center processing devices 30, reducing the load. Accordingly, there may be a tradeoff between reliability and load, such that operation parameters of the data center can be adjusted to improve a user experience.

In an example, the processing device 30 and/or the control unit 50 may be further configured to use a threshold for identifying an erroneous operation state. For example, if a physical parameter of the processing device 30, e.g., a temperature, exceeds the threshold the operation state of the processing device 30 may be assigned as erroneous operation state. Thus, the operation state of the processing device 30 can be determined in an improved way.

In an example, the processing device 30 and/or the control unit 50 may be further configured to perform an action based on a policy. For example, the policy may be linked to the threshold, e.g., if the threshold is exceeded a processing device 30 is restarted and/or shut down. Thus, a management of the processing device 30 can be improved. For example, the policies can be defined/maintained by an administrator of the electronic device 80.

In an example, the processing device 30 and/or the control unit 50 may be further configured to define and/or edit the threshold and/or the policy. For example, an administrator may use the processing device 30 and/or the control unit 50 to increase a threshold, e.g., to increase a number of active processing 30 devices to reduce a load of a server.

In an example, the processing device 30 and/or the control unit 50 may be further configured to determine whether an erroneous operation state is recoverable or non-recoverable. In principle, an erroneous operation state may be defined by two states, recoverable (e.g., graceful/recoverable erroneous operation state) and non-recoverable (e.g., cater). Thus, the processing device 30 and/or the control unit 50 can determine an action for a processing device 30 having an erroneous operation state, e.g., restart (recoverable erroneous operation state) or shut down (non-recoverable erroneous operation state).

In an example, if the erroneous operation state is recoverable the processing device 30 and/or the control unit 50 may be further configured to restore a non-erroneous operation state of the processing device 30. For example, the restore may be performed by a restart of the processing device 30 (e.g., launched by the control unit 50 or by the processing device 30 on its own).

In an example, the processing device 30 and/or the control unit 50 may be further configured to track a number of threshold exceedance to assign the processing device 30 as non-recoverable erroneous operation state when the number of threshold exceedance for the processing device 30 exceeds a predefined number of threshold exceedance. Thus, the processing device 30 may be assigned having a non-recoverable erroneous operation state even if an actual erroneous operation state may be recoverable. Thus, a processing device 30 may be shut down due to multiple erroneous operation states in time, which may increase a user experience since a reliability may be increased.

In an example, the control unit 50 may be further configured to migrate operations addressed to the processing device 30 to a surrogate processing device. In an example, the control unit 50 may be further configured to migrate operations from the surrogate processing device back to the processing device 30. In an example, the control unit 50 may be further configured to migrate operations addressed to the follower processing device to a surrogate follower processing device. In an example, the control unit 50 may be further configured to migrate operations from the surrogate follower processing device back to the follower processing device. Thus, a migration of an executed instruction can be performed by the control unit 50. For example, if the processing device 30 may have an erroneous operation state the executed instruction may be migrated to the surrogate processing device, such that a lock-stop mode can be retained. Optionally or alternatively, if the processing device 30 may have an erroneous operation state the executed instruction may be migrated from the follower processing device to the surrogate follower processing device, such that a lock-stop mode can be retained as it is migrated to a new pair of processing devices (new processing device and new follower processing device). Thus, a service of the lock-step mode can be improved, e.g., there may be no service disruption to a workload of the electronic device 80.

In an example, the electronic device 80 may be a personal computer, smartphone, notebook, smart device and/or cloud computing.

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIGS. 1-2) and/or below (e.g., FIG. 3-7).

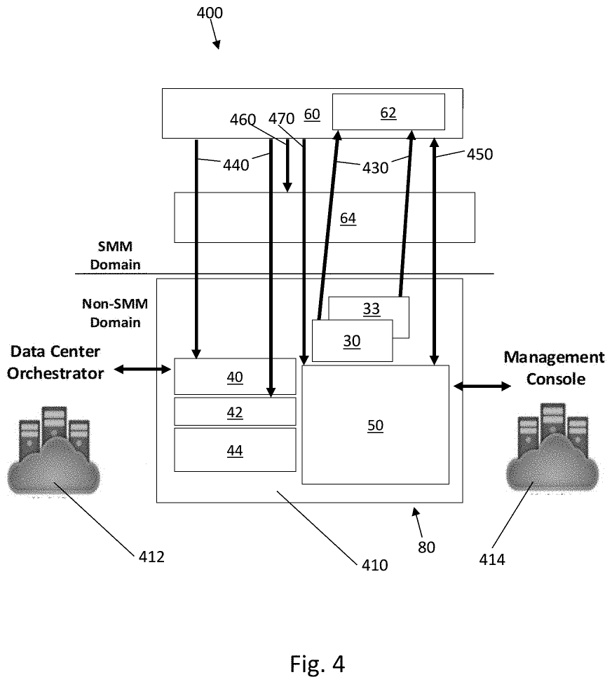

FIG. 4 shows an example of a system architecture of a system 400 including the electronic device 80 from FIG. 3. The electronic device 80 may comprises a control unit 50 (e.g., as described with reference to FIG. 2), a processing device 30 (e.g., as described with reference to FIG. 1) and a follower processing device 33. The system 400 comprises a platform 410 (e.g., a platform 410 of the electronic device 80). The platform 410 comprises the control unit 50, the processing device 30 (also referred as core), the follower processing device 33 (also referred as follower core), a virtual machine manager 40, a guest operation system 42 (OS) and a console application 44.

Typically, in OS/VMM 40, 42 aware lock-step core management, if one of the two lock step cores 30, 33 hit a (hardware) error, the core 30, 33 may generate a system management interrupt 430 (SMI), that may be handled by a SMI handler 62 in basic input/output system (BIOS) system management mode (SMM). A BIOS SWIM Handler 60 may notify the guest OS/VMM 40, 42 and the platform 410 using a direct lock-step mode (DLSM) VMM alert message 440 or DLSM BMC alert message 450, respectively. The BIOS SWIM Handler 60 may perform actions based on policies provisioned the control unit 50, e.g., a board management controller (BMC). A BIOS SMI transfer monitor (STM) 64 and/or the BMC 50 can track telemetry of both cores 30, 33 as well as the instruction buffer from the failed socket, e.g., for record keeping/auditing/debug purpose. For example, the BIOS STM 64 and/or the BMC 50 may receive DLSM telemetry STM message 460 or DLSM telemetry BMC message 470, respectively.

Further, the VMM 40 can inform the guest OS 42 or the console application 44 on an erroneous operation state of the core 30 and limited resiliency thereby the guest OS 42 or the console application 44 can gracefully migrate execution information or shut down the core. The BMC 52 can inform an orchestrator 412 (e.g., of a data center) about the erroneous operation state of the core 30.

The BMC 52 may comprise a BMC failover applet that hosts a core logic. The core logic may be configured to provide/maintain a threshold and/or a (configurable) policy. The threshold/configurable policies can be provisioned via Out-Of-Band (OOB) BMC remote console. Further, assertion on an erroneous operation state of the core 30 and/or any preliminary lockstep failure (caused by an erroneous operation state), along with workload configuration and/or an observing circuitries configuration (e.g., PMU configuration) can be logged and communicated to the orchestrator 412 or a remote admin for record keeping and/or root causing.

For example, policy-based actions (e.g., throttle the specific core 30/uncore/socket to mitigate the correctable errors, alert platform VMM 40, guest OS 42 and/or orchestrator 412 to migrate workload to avoid data loss, offline specific cores/socket, etc. in conjunction with platform power management unit.

Further, the BMC 52 can assert a DLSM BMC alert message 450 (e.g., a DLSM Failover# message) that can be handled via SMM Handler 60 in BIOS SWIM mode. The STM 64 may receive a DLSM telemetry STM message 460 (e.g., a DLSM Failover Telemetry) provide opaque logging and/or telemetry data that it may want to protect from a potentially vulnerable VMM 40. Thus, a security may be increased. Further, the STM 64 may allow a transmission of the opaque logging and/or telemetry date to a management console 414 (e.g., a data center management console), e.g., via the BMC 52.

Thus, the system architecture of the system 400 provides capabilities in terms of telemetry and/or policy-based prioritization while handling concurrent or multiple lock-step core(s) erroneous operation states within a socket along with run time support and orchestration of BMC 52. This may be crucial especially in terms of bringing down Defects Per Million (DPM), e.g., at a data center.

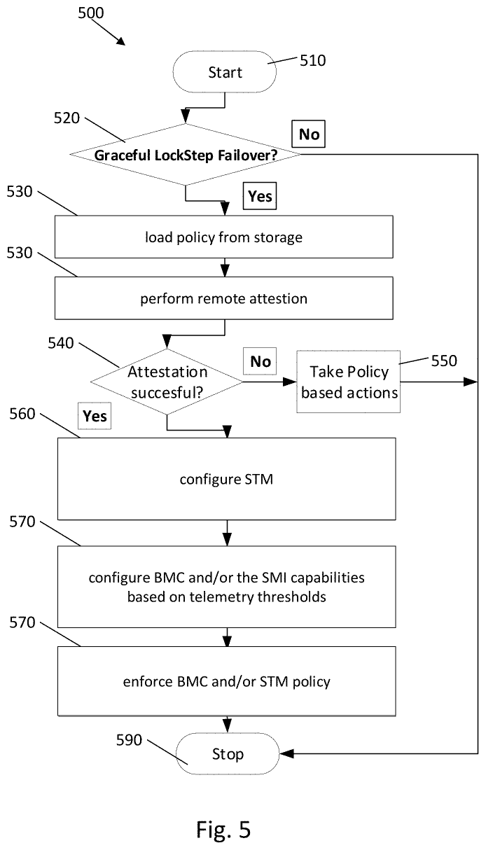

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIGS. 1-3) and/or below (e.g., FIG. 5-7).

FIG. 5 shows a flow chart of an example of a method 500. The method 500 comprises the determination 510 of an operation state of a core (e.g., a processing device). If the operation state is erroneous, it will be determined 520 if the erroneous operation state is recoverable (e.g., graceful error) or non-recoverable.

In principle, as mentioned above, an erroneous operation state may be defined by two states, recoverable (e.g., graceful operation state) and non-recoverable (e.g., cater). For example, if a recoverable (temporary) erroneous operation state is caused by a hardware failure a reason could be a thermal issue, clock issue, poison creation events that can be clearly identified as local to the core (e.g., the processing device and/or the follower processing device), etc. For example, if a non-recoverable erroneous operation state is caused by a hardware failure a reason could be a core with uncorrectable error, damaged or non-responsive core, temporary errors hitting a present threshold or hitting frequently (as described above), other conditions that incapacitate the core, etc.

By separating between recoverable and non-recoverable erroneous operation states a system can be kept active even if a core has a non-recoverable erroneous operation state such that reducing/eliminating platform down time. The system can continue operation, e.g., in lockstep mode by migrating execution instruction to a remaining surrogate core or by terminating the lock-step mode by shutting-down only one core (e.g., the processing device having a non-recoverable erroneous operation state) involved in the lock-step mode (and operating on the left core, e.g., the follower processing device, in non-lock step mode). Thus, a performance of the system can be improved and/or a user experience can be increased.

If a core is identified as having a non-recoverable erroneous operation state, the method 500 may be stopped 590. In the art, because of the missing determination if the erroneous operation state is recoverable or non-recoverable no further processing would be possible. Thus, by separating between recoverable and non-recoverable erroneous operation states the system is enabled to perform further operations on a core which is in a recoverable erroneous operation state.

Further, by separating between recoverable and non-recoverable erroneous operation states different implementation how to deal with/identify each erroneous operation state can be implemented. For example, to separate between a recoverable erroneous operation state and a non-recoverable erroneous operation state a first threshold and a second threshold may be defined, e.g., a first temperature and a second temperature. If a core hits the first temperature the core may be identified having a recoverable erroneous operation state and if the core hits the second temperature the core may be identified having a non-recoverable erroneous operation state.

For example, if the core is identified having a recoverable erroneous operation state a policy may be used to define further operations, e.g., a policy may allow temporary degraded modes where the lock-step core that hit the problem may recover and reset to full throttle once errors are recovered. The policy may be loaded 530 from a (secure) storage device.

For example, a policy may define a maximum number of erroneous operation state and if a specific lock-step core hits the maximum number, a bypass mechanism to turn off lock-step mode and to allow running in non-lock step mode for the left core until a service of the core having an erroneous operation state may be restored or replaced by migration to a surrogate core to restart lock-step mode. Alternatively, a lock-step mode can be migrated to a pair of surrogate lock-step cores.

Further, policy-based actions can be enforced, e.g., (lock-step) cores having an erroneous operation state can be throttled, bypassed or a workload can be migrated based on a service level agreement requirement. Additionally, a (follower or surrogate) core can retrieve a buffer and any metric via point-to-point processor interconnect before the other core is reset based on BMC policies and/or the BMC can retrieve how much of info may depend on the type of error.

For each STM interface module (e.g., platform, BMC, etc.) a remote attestation can be performed 540. If the check of the remote attestation 540 indicates no success a policy-based action may be performed 550, e.g., the method 500 may be stopped 590. If the check of the remote attestation 540 indicates success a STM can be configured 560 with appropriate telemetry thresholds for a lock-step mode. The telemetry thresholds may be used to configure 570 the BMS and/or the SMI capabilities. Further, the BMC and/or STM policy may be enforced 580 before the method is stopped 590.

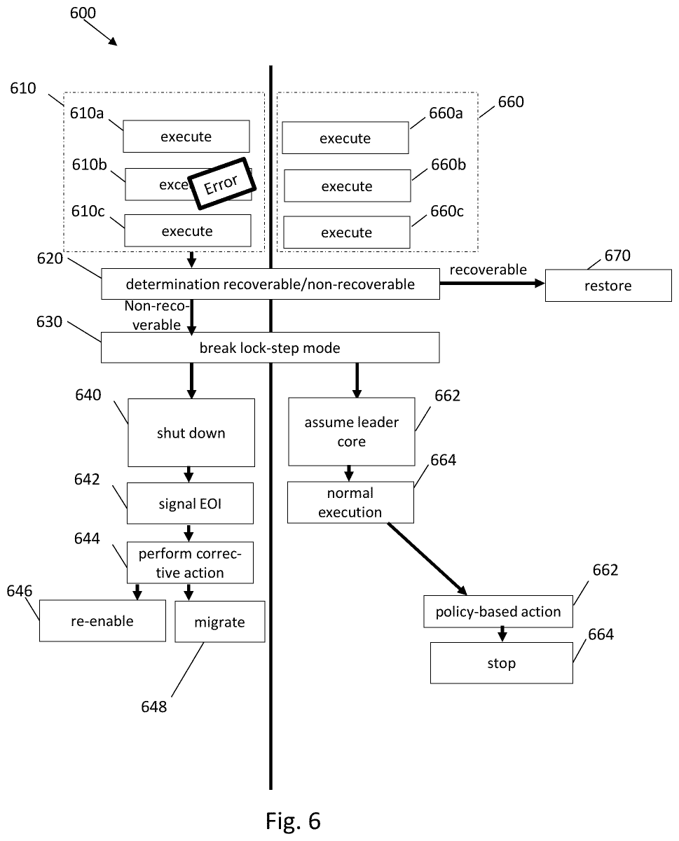

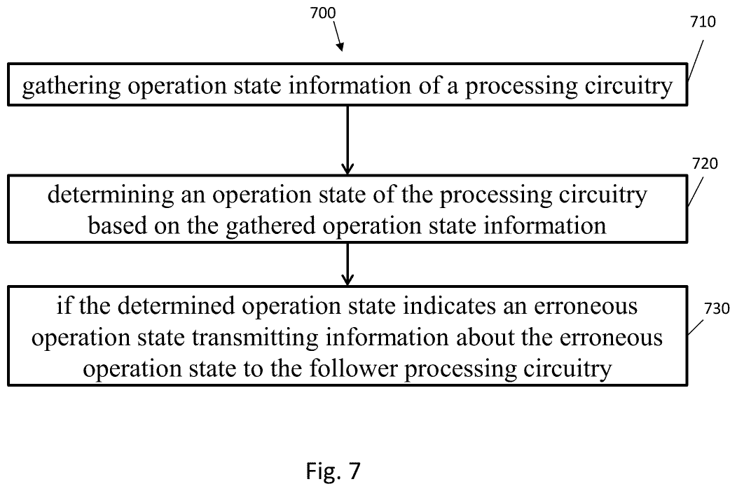

More details and aspects are mentioned in connection with the examples described above and/or below. The example shown in FIG. 5 may comprise one or more optional additional features corresponding to one or more aspects mentioned in connection with the proposed concept or one or more examples described above (e.g., FIGS. 1-4) and/or below (e.g., FIG. 6-7).

FIG. 6 shows a flow chart of another example of a method 600. The method 600 comprises two cores 610, 660, a leader core 610 and a follower core 660, which are configured in lockstep mode. The leader core 610 is responsible for maintaining the lock-step mode. Both cores 610, 660 may execute several instructions 510a, 510b and 510c and 560a, 560b and 560c, respectively. The leader core 610 has an erroneous operation state during executing an instruction 610b. In the art, if one of both cores 610, 660 is in an erroneous operation state both cores 610, 660 need to be shut down. This way, the lock-step mode is terminated.

Instead of shutting-down both cores 610, 660 it can be determined 620 if the erroneous operation state is recoverable or non-recoverable. If an erroneous operation state can be corrected (e.g., be restarting the leader core), then a corrective action can be taken, operation may be restored 670 to normal, and an entry may be made in the system event log.

If an erroneous operation state is non-recoverable the system may attempt to break 630 lockstep operation, assign Advanced Programmable Interrupt Controller responsibilities to the remaining good partner core, the follower core 660. Further, a lockstep machine check on each core 610, 660 may be pended and a non-maskable interrupt may be send to both cores 610, 660 to break out of the lock-step mode. Thus, the system has not to be shut down since the follower core 660 is still operable. Solely the leader core 610 may be shut down 640.

Upon a successful lock-step mode break, the follower core 660 may assume 662 responsibilities of the lockstep mode (as new “leader core”) and continues 664 execution of the instruction in non-lockstep mode until operation is completed, migrated to a new lockstep core pair or lock-step mode is re-enabled, e.g., by signaling an EOI 642.

After a performed pended machine check an end of interrupt may be signalized 642, e.g., by a system software. Corrective action may be performed 644, e.g., by an admin of the system. The corrective action may result in a re-enabling 646 of the lock-step mode by re-enabling the leader core 610 or by migrating 648 execution instruction to a surrogate leader core. After migration the surrogate core may be assumed to be the leader core and the follower core 660 may be assumed to be again the follower core. Thus, the normal lock-step mode operation can be continued.

The machine check generated error data may carry information about an error source, an error reason and/or a lockstep break status which is sent to an OS/VMM for processing.

Further, a BIOS SMM Handler (e.g., as described with reference to FIG. 5) may have the capability to queue up the machine check generated error data from a machine check bank that can be processed based on the configured policy-based order (e.g. FIFO). This provides the capability to scale out and scale-up in terms of handling array of cores across one or more sockets.

When the OS/VMM receives the machine check, it may determine if the erroneous operation state was recoverable (e.g., temporary) or non-recoverable (permanent). In case of both recoverable and non-recoverable errors, the OS/VMM may notify user to take corrective action, e.g., identify the partner code that is assuming responsibilities of lockstep operation and record the errors. Further, when OS/VMM may have completed processing the machine check and system resumes to normal operation with follower core 660 in lock-step mode.

For example, if an erroneous operation state is recoverable, a user may examine the cause of failure and may perform (corrective) action to recover, where recovery is possible. For instance, if the cause of the recoverable erroneous operation state is related to a core temperature, then the user may monitor the core temperature until it is restored to normal operating core temperature and then perform corrective action.

After a successful recovery, the user may restart the DLSM on the two cores 610, 660 using the current state of the follower core 660 that continued to service operation in non-lock step mode. For a non-recoverable erroneous operation state, the user may choose to offline the bad core permanently. Additionally, if the workload requires lock step resiliency, then the user may choose to migrate the work to a surrogate leader core or to a new pair of lock step cores. The OS/VMM may provide a mechanism to support all of the recovery or migration operations to a privileged user.

More details and aspects are mentioned in connection with the examples described above and/or below. The example shown in FIG. 6 may comprise one or more optional additional features corresponding to one or more aspects mentioned in connection with the proposed concept or one or more examples described above (e.g., FIGS. 1-5) and/or below (e.g., FIG. 7-7).

FIG. 7 shows an example of another method 700. The method 700 comprises gathering 710 operation state information of a processing circuitry and determining 720 an operation state of the processing circuitry based on the gathered operation state information. Further, if the determined operation state indicates an erroneous operation state the method 700 comprises transmitting 730 information about the erroneous operation state to the follower processing circuitry. For example, the method can be performed by a processing unit as describe with reference to FIG. 1 or by a control unit as described with reference to FIG. 2.

More details and aspects are mentioned in connection with the examples described above. The example shown in FIG. 7 may comprise one or more optional additional features corresponding to one or more aspects mentioned in connection with the proposed concept or one or more examples described above (e.g., FIG. 1-6).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g., example 1) relates to a processing device, comprising one or more interfaces configured to transmit information to a follower processing circuitry; and processing circuitry configured to control the one or more interfaces and to: gather operation state information of the processing circuitry; determine an operation state of the processing circuitry based on the gathered operation state information; and if the determined operation state indicates an erroneous operation state transmit information about the erroneous operation state to the follower processing circuitry.

Another example (e.g., example 2) relates to a previously described example (e.g., example 1) wherein the processing circuitry is further configured to: transmit an output of an instruction executed by the processing circuitry to a comparator circuitry; receive comparison information about a lock-step operation from the comparator circuitry; and wherein the determination of the operation state is based on the gathered operation state information and the comparison information.

Another example (e.g., example 3) relates to a control unit, comprising one or more interfaces configured to communicate with a processing device and a follower processing device; and control unit configured to control the one or more interfaces and to: gather operation state information of the processing device; determine an operation state of the processing device based on the gathered operation state information; and if the determined operation state indicates an erroneous operation state transmit information about the erroneous operation state to the follower processing device and/or the processing device.

Another example (e.g., example 4) relates to an electronic device, comprising the processing device (e.g., the processing device of example 1 or 2) and/or the control unit (e.g., the control unit of example 3).

Another example (e.g., example 5) relates to a previously described example (e.g., example 4) further comprising observing circuitry configured to: observe the operation state of the processing device and/or the follower processing device; and transmit information about the observed operation state to the processing device and/or the control unit.

Another example (e.g., example 6) relates to a previously described example (e.g., example 4 or 5) wherein the control unit is further configured to store information about an operation state of the processing device.

Another example (e.g., example 7) relates to a previously described example (e.g., one of the examples 4-6) further comprising transfer circuitry configured to: receive telemetry information about the processing circuitry and/or the follower processing circuitry from a system management domain; and transmit the received telemetry information to a management console.

Another example (e.g., example 8) relates to a previously described example (e.g., one of the examples 4-7) wherein the processing device and/or the control unit is further configured to use a threshold for identifying an erroneous operation state.

Another example (e.g., example 9) relates to a previously described example (e.g., one of the examples 4-8) wherein the processing device and/or the control unit is further configured to perform an action based on a policy.

Another example (e.g., example 10) relates to a previously described example (e.g., example 8 or 9) wherein the processing device and/or the control unit is further configured to define and/or edit the threshold and/or the policy.

Another example (e.g., example 11) relates to a previously described example (e.g., one of the examples 4-10) wherein the processing device and/or the control unit is further configured to determine whether an erroneous operation state is recoverable or non-recoverable.

Another example (e.g., example 12) relates to a previously described example (e.g., example 11) wherein if the erroneous operation state is recoverable the processing device and/or the control unit is further configured to restore a non-erroneous operation state of the processing device.

Another example (e.g., example 13) relates to a previously described example (e.g., one of the examples 8-12) wherein the processing device and/or the control unit is further configured to track a number of threshold exceedance to assign the processing device as non-recoverable erroneous operation state when the number of threshold exceedance for the processing device exceeds a predefined number of threshold exceedance.

Another example (e.g., example 14) relates to a previously described example (e.g., one of the examples 4-13) wherein the control unit is further configured to migrate operations addressed to the processing device to a surrogate processing device.

Another example (e.g., example 15) relates to a previously described example (e.g., example 14) wherein the control unit is further configured to migrate operations from the surrogate processing device back to the processing device.

Another example (e.g., example 16) relates to a previously described example (e.g., one of the examples 4-15) wherein the control unit is further configured to migrate operations addressed to the follower device to a surrogate follower processing device.

Another example (e.g., example 17) relates to a previously described example (e.g., one of the examples 16) wherein the control unit is further configured to migrate operations from the surrogate processing device back to the processing device.

Another example (e.g., example 18) relates to a previously described example (e.g., one of the examples 4-17) wherein the electronic device is a personal computer, smartphone, notebook, smart device and/or cloud computing.

personal computer and/or cloud computing.

An example (e.g., example 19) relates to a method, comprising: gathering operation state information of a processing circuitry; determining an operation state of the processing circuitry based on the gathered operation state information; and if the determined operation state indicates an erroneous operation state transmitting information about the erroneous operation state to the follower processing circuitry.

Another example (e.g., example 20) relates to a previously described example (e.g., example 19) further comprising observing the operation state of the processing circuitry and/or the follower processing circuitry by an observing circuitry; and transmitting information about the observed operation state from the observing circuitry to the processing circuitry and/or a control unit.

Another example (e.g., example 21) relates to a previously described example (e.g., one of the examples 19-20) further comprising storing information about an operation state of the observing circuitry.

Another example (e.g., example 22) relates to a previously described example (e.g., one of the examples 19-21) further comprising using a threshold for identifying an erroneous operation state.

Another example (e.g., example 23) relates to a previously described example (e.g., one of the examples 19-22) further comprising performing an action based on a policy.

Another example (e.g., example 24) relates to a previously described example (e.g., one of the examples 19-23) further comprising determining whether an erroneous operation state is recoverable or non-recoverable.

Another example (e.g., example 25) relates to a previously described example (e.g., one of the examples 19-24) further comprising receiving telemetry information about the processing device and/or the follower processing device from a system management domain; and transmitting the received telemetry information to a management console.

Another example (e.g., example 26) relates to a previously described example (e.g., one of the examples 22-25) further comprising defining and/or editing the threshold and/or the policy.

Another example (e.g., example 27) relates to a previously described example (e.g., one of the examples 24-26) further comprising if the erroneous operation state is recoverable restoring a non-erroneous operation state of the processing device.

Another example (e.g., example 28) relates to a previously described example (e.g., one of the examples 22-27) further comprising tracking a number of threshold exceedance to assign the processing device as non-recoverable erroneous operation state when the number of threshold exceedance for the processing device exceeds a predefined number of threshold exceedance.

Another example (e.g., example 29) relates to a previously described example (e.g., one of the examples 22-28) further comprising migrating operations addressed to the processing device to a surrogate processing device.

Another example (e.g., example 30) relates to a previously described example (e.g., one of the examples 22-29) further comprising migrating operations from the surrogate processing device back to the processing device.

Another example (e.g., example 31) relates to a previously described example (e.g., one of the examples 22-30) further comprising migrating operations addressed to the follower processing device to a surrogate follower processing device.

Another example (e.g., example 32) relates to a previously described example (e.g., one of the examples 22-31) further comprising migrating operations from the surrogate processing device back to the processing device.

An example (e.g., example 33) relates to a computer program having a program code for performing the method according to e.g., example 19-32, when the computer program is executed on a computer, a processor, or a programmable hardware component.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A processing device, comprising
one or more interfaces configured to transmit information to a follower processing circuitry; and
processing circuitry configured to control the one or more interfaces and to:
gather operation state information of the processing circuitry;
determine an operation state of the processing circuitry based on the gathered operation state information; and
if the determined operation state indicates an erroneous operation state transmit information about the erroneous operation state to the follower processing circuitry.

2. The processing device according to claim 1, wherein
the processing circuitry is further configured to:
transmit an output of an instruction executed by the processing circuitry to a comparator circuitry;
receive comparison information about a lock-step operation from the comparator circuitry; and
wherein the determination of the operation state is based on the gathered operation state information and the comparison information.

3. The processing device according to claim 1, wherein
the processing device is further configured to use a threshold for identifying an erroneous operation state.

4. The processing device according to claim 3, wherein
the processing device is further configured to perform an action based on a policy.

5. The processing device according to claim 4, wherein
the processing device is further configured to define and/or edit the threshold and/or the policy.

6. The processing device according to claim 1, wherein
the processing device is further configured to determine whether an erroneous operation state is recoverable or non-recoverable.

7. The processing device according to claim 6, wherein
if the erroneous operation state is recoverable the processing device is further configured to restore a non-erroneous operation state of the processing device.

8. The processing device according to claim 3, wherein
the processing device is further configured to track a number of threshold exceedance to assign the processing device as non-recoverable erroneous operation state when the number of threshold exceedance for the processing device exceeds a predefined number of threshold exceedance.

9. A control unit, comprising
one or more interfaces configured to communicate with a processing device and a follower processing device; and
control unit configured to control the one or more interfaces and to:
gather operation state information of the processing device;
determine an operation state of the processing device based on the gathered operation state information; and
if the determined operation state indicates an erroneous operation state transmit information about the erroneous operation state to the follower processing device and/or the processing device.

10. The control unit according to claim 9, further comprising
observing circuitry configured to:
observe the operation state of the processing device and/or the follower processing device; and
transmit information about the observed operation state to the control unit.

11. The control unit according to claim 9, wherein
the control unit is further configured to store information about an operation state of the processing device.

12. The control unit according to claim 9, further comprising
transfer circuitry configured to:
receive telemetry information about the processing device and/or the follower processing device from a system management domain; and
transmit the received telemetry information to a management console.

13. The control unit according to claim 9, wherein
the processing device is further configured to use a threshold for identifying an erroneous operation state.

14. The control unit according to claim 13, wherein
the control unit is further configured to perform an action based on a policy.

15. The control unit according to claim 14, wherein
the control unit is further configured to define and/or edit the threshold and/or the policy.

16. The control unit according to claim 9, wherein
the control unit is further configured to determine whether an erroneous operation state is recoverable or non-recoverable.

17. The control unit according to claim 16, wherein
if the erroneous operation state is recoverable the control unit is further configured to restore a non-erroneous operation state of the processing device.

18. The control unit according to claim 13, wherein
the control unit is further configured to track a number of threshold exceedance to assign the processing device as non-recoverable erroneous operation state when the number of threshold exceedance for the processing device exceeds a predefined number of threshold exceedance.

19. The control unit according to claim 9, wherein
the control unit is further configured to migrate operations addressed to the processing device to a surrogate processing device.

20. The control unit according to claim 9, wherein
the control unit is further configured to migrate operations from the surrogate processing device back to the processing device.

21. The control unit according to claim 9, wherein
the control unit is further configured to migrate operations addressed to the follower processing device to a surrogate follower processing device.

22. The control unit according to claim 9, wherein
the control unit is further configured to migrate operations from the surrogate processing device back to the processing device.

23. A method, comprising:
gathering operation state information of a processing circuitry;
determining an operation state of the processing circuitry based on the gathered operation state information; and
if the determined operation state indicates an erroneous operation state transmitting information about the erroneous operation state to the follower processing circuitry.

24. The method according to claim 23, further comprising
observing the operation state of the processing circuitry and/or the follower processing circuitry by an observing circuitry; and
transmitting information about the observed operation state from the observing circuitry to the processing circuitry and/or a control unit.

25. A non-transitory, computer-readable medium comprising a program code that, when the program code is executed on a computer, a processor, or a programmable hardware component, performs gathering operation state information of a processing circuitry, determining an operation state of the processing circuitry based on the gathered operation state information and if the determined operation state indicates an erroneous operation state transmitting information about the erroneous operation state to the follower processing circuitry.
